(19) United States
(12) Patent Application Publication
(10) Pub. No.: US 2025/0016880 A1
(43) Pub. Date: Jan. 9, 2025

(54) METHOD AND APPARATUS FOR SUPPORTING PLURALITY OF SIMS IN NEXT-GENERATION MOBILE COMMUNICATION SYSTEM

(71) Applicant: Samsung Electronics Co., Ltd., Gyeonggi-do (KR)

(72) Inventors: Sangbum KIM, Gyeonggi-do (KR); Sangyeob JUNG, Gyeonggi-do (KR)

(21) Appl. No.: 18/712,589

(22) PCT Filed: Nov. 21, 2022
(86) PCT No.: PCT/KR2022/018428

§ 371 Date: May 22, 2024

(30) Foreign Application Priority Data
Nov. 22, 2021 (KR) 10-2021-0161051

(51) Int. Cl. H04W 76/30; H04W 8/18; H04W 24/10

(52) U.S. Cl. CPC H04W 76/30; H04W 8/183; H04W 24/10

(57) ABSTRACT

The present disclosure relates to a 5G or 6G communication system for supporting a higher data transmission rate. The present invention may provide a method capable of smoothly performing a standby mode or connection mode operation in other networks by considering multi-SIM user equipment.

### TECHNICAL FIELD

The disclosure relates to terminal and base station operations in a mobile communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning. Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure is to provide a method capable of smoothly performing a standby mode or connection mode operation in another network in consideration of a multi-SIM terminal.

The technical subjects pursued in the disclosure may not be limited to the above-mentioned technical subjects, and other technical subjects which are not mentioned may be clearly understood, through the following descriptions, by those skilled in the art to which the disclosure pertains.

### Solution to Problem

To solve the tasks described above, a method performed by a terminal according to an embodiment of the disclosure may include identifying that the terminal performing communication with a first base station associated with a first subscriber identity module (SIM) by using a first radio frequency (RF) chain and a second RF chain needs to communicate with a second base station associated with a second SIM by using the second RF chain, transmitting, to the first base station, a first message including information for requesting a change of a configuration of at least one serving cell associated with the second RF chain, and as a response to the first message, receiving, from the first base station, a second message including information indicating the change of the configuration of the at least one serving cell associated with the second RF chain.

In addition, the change of the configuration of the at least one serving cell associated with the second RF chain may include at least one of deactivating or releasing the at least one serving cell associated with the second RF chain, configuring a scheduling gap for the at least one serving cell associated with the second RF chain, or changing the at least one serving cell associated with the second RF chain to a frequency band not associated with the second RF chain.

In addition, the method may further include transmitting, to the first base station, a third message comprising capability information of the terminal including information on whether the terminal supports changing of the configuration of the at least one serving cell associated with the second RF chain, and receiving, from the first base station, a fourth message including configuration information for configuring the changing of the configuration of the at least one serving cell associated with the second RF chain.

In addition, the information for requesting the change of the configuration of the at least one serving cell associated with the second RF chain may include at least one of information on the at least one serving cell, information on a frequency or frequency band of the at least one serving cell, information on a cell group including the at least one serving cell, scheduling gap pattern information preferred by the terminal, information on the at least one serving cell's frequency or frequency band to be changed, which is preferred by the terminal, or information indicating that a purpose is to solve a collision in a multi-SIM environment.

In addition, to solve the tasks described above, a method performed by a first base station according to an embodiment of the disclosure may include, when a terminal performing communication with the first base station associated with a first subscriber identity module (SIM) by using a first radio frequency (RF) chain and a second RF chain needs to communicate with a second base station associated with a second SIM by using the second RF chain, receiving, from the terminal, a first message including information for requesting a change of a configuration of at least one serving cell associated with the second RF chain, and as a response to the first message, transmitting, to the terminal, a second message including information indicating the change of the configuration of the at least one serving cell associated with the second RF chain.

In addition, the method may further include receiving, from the terminal, a third message including capability information of the terminal including information on whether the terminal supports changing of the configuration of the at least one serving cell associated with the second RF chain, and transmitting, to the terminal, a fourth message including configuration information for configuring the changing of the configuration of the at least one serving cell associated with the second RF chain.

In addition, to solve the tasks described above, a terminal according to an embodiment of the disclosure may include a transceiver; and a controller connected to the transceiver and configured to identify that the terminal performing communication with a first base station associated with a first subscriber identity module (SIM) by using a first radio frequency (RF) chain and a second RF chain needs to communicate with a second base station associated with a second SIM by using the second RF chain, transmit, to the first base station, a first message including information for requesting a change of a configuration of at least one serving cell associated with the second RF chain, and as a response to the first message, receive, from the first base station, a second message including information indicating the change of the configuration of the at least one serving cell associated with the second RF chain.

In addition, to solve the tasks described above, a first base station according to an embodiment of the disclosure may include a transceiver; and a controller connected to the transceiver and configured to, when a terminal performing communication with the first base station associated with a first subscriber identity module (SIM) by using a first radio frequency (RF) chain and a second RF chain needs to communicate with a second base station associated with a second SIM by using the second RF chain, receive, from the terminal, a first message including information for requesting a change of a configuration of at least one serving cell associated with the second RF chain, and as a response to the first message, transmit, to the terminal, a second message including information indicating the change of the configuration of the at least one serving cell associated with the second RF chain.

### Advantageous Effects of Invention

According to an embodiment of the disclosure, a method capable of smoothly performing a standby mode or connection mode operation in another network in consideration of a multi-SIM terminal may be provided.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1A is a diagram illustrating a structure of a next-generation mobile communication system according to an embodiment of the disclosure.

FIG. 1B is a diagram for illustrating a radio access state transition in a next-generation mobile communication system according to an embodiment of the disclosure:

FIG. 1C is a diagram illustrating a terminal supporting multiple subscriber identity modules (SIMs) according to an embodiment of the disclosure:

FIG. 1D is a diagram for illustrating scenarios in which a terminal having multiple RF chains receives services from multiple networks corresponding to different SIMs according to an embodiment of the disclosure;

FIG. 1E is a flowchart of operations for performing deactivation or release based on a terminal request according to an embodiment of the disclosure;

FIG. 1F is a flowchart of operations for performing scheduling suspension (scheduling gap) periodically or aperiodically based on a terminal request according to an embodiment of the disclosure.

FIG. 1G is a flowchart of operations for performing SCG change based on a terminal request according to an embodiment of the disclosure;

FIG. 1H is a flowchart of operations for performing inter-frequency or inter-band handover based on a terminal request according to an embodiment of the disclosure:

FIG. 1I is a flowchart of operations for determining cell reselection priority information based on a terminal request according to an embodiment of the disclosure;

FIG. 1J is a flowchart of terminal operations for operations based on a terminal request according to an embodiment of the disclosure;

FIG. 1K is a flowchart of base station operations for operations based on a terminal request according to an embodiment of the disclosure:

FIG. 1L is a diagram for illustrating a problem of insufficient terminal transmission power when a terminal having multiple RF chains receives services from multiple networks corresponding to different SIMs according to an embodiment of the disclosure;

FIG. 1M is a flowchart of operations for performing TDM scheduling based on a terminal request according to an embodiment of the disclosure,

FIG. 1O is a block diagram illustrating an internal structure of a terminal according to an embodiment of the disclosure; and

FIG. 1P is a block diagram illustrating a configuration of a base station according to an embodiment of the disclosure.

### MODE FOR THE INVENTION

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings. The terms which will be described below are terms defined in consideration of the functions in the disclosure, and may be different according to users, intentions of the users, or customs. Therefore, the definitions of the terms should be made based on the contents throughout the specification.

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings.

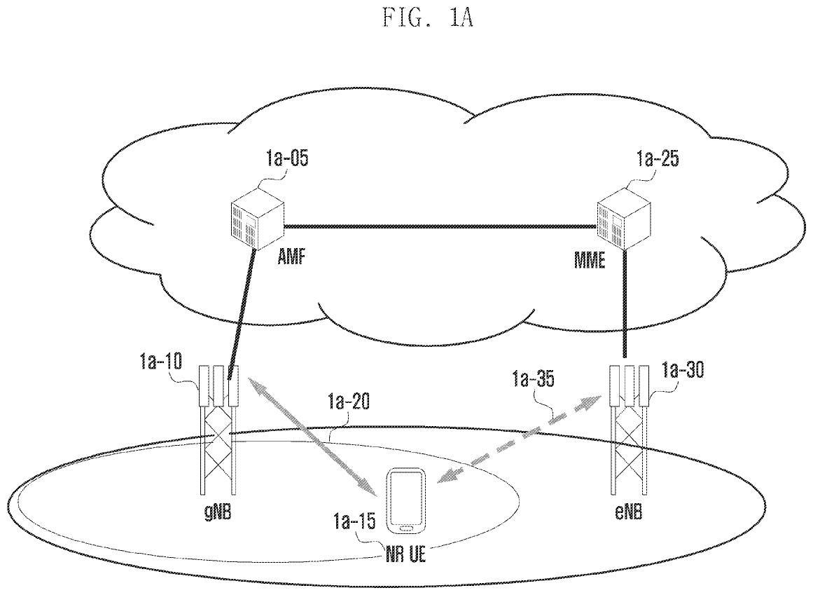

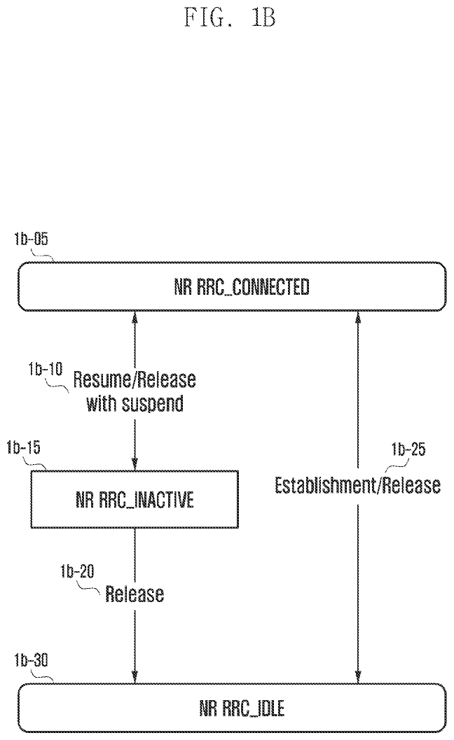

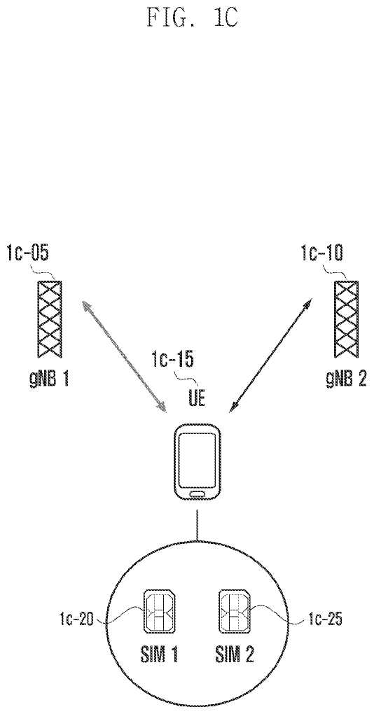

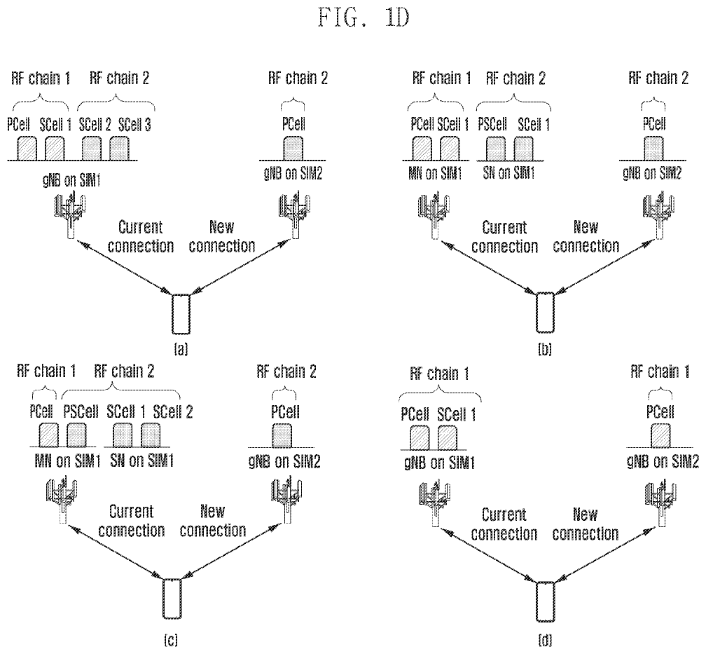

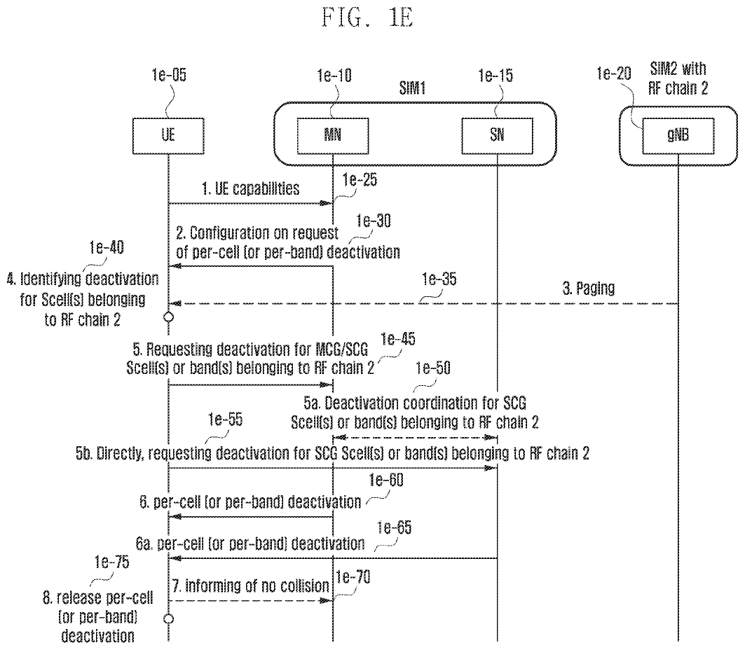

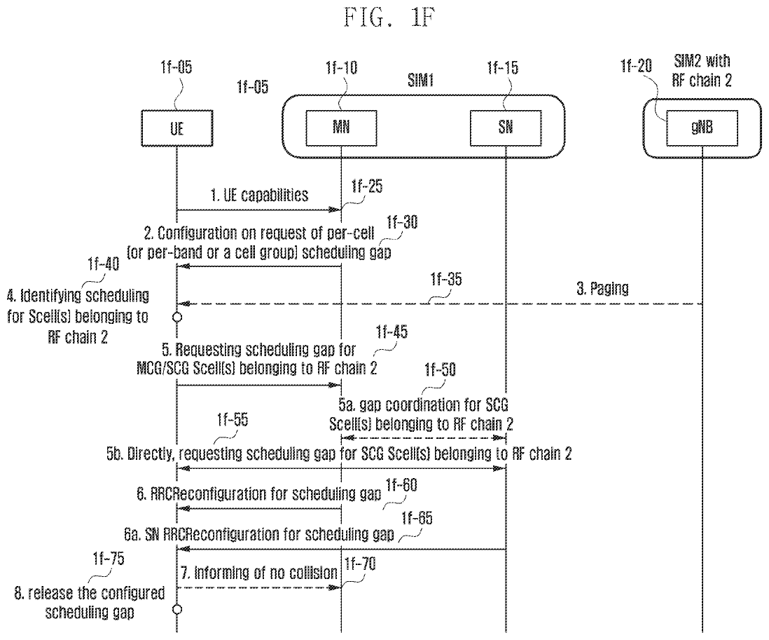

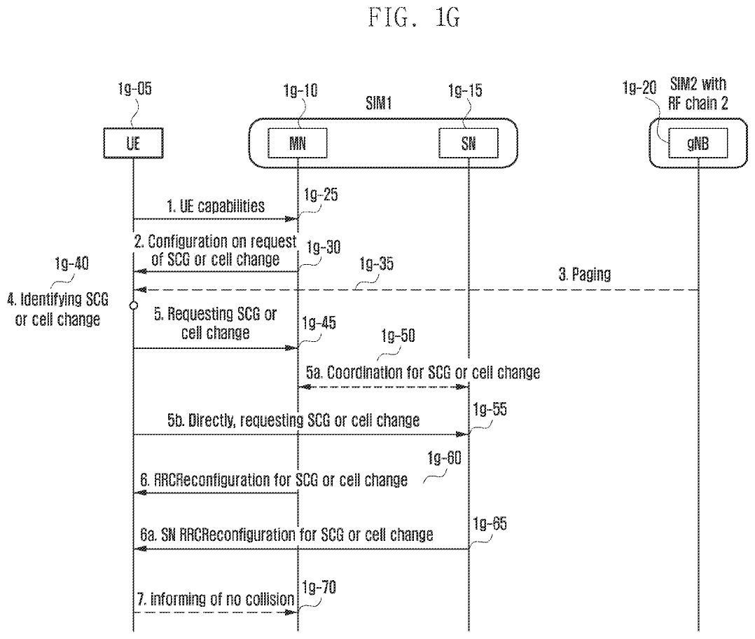

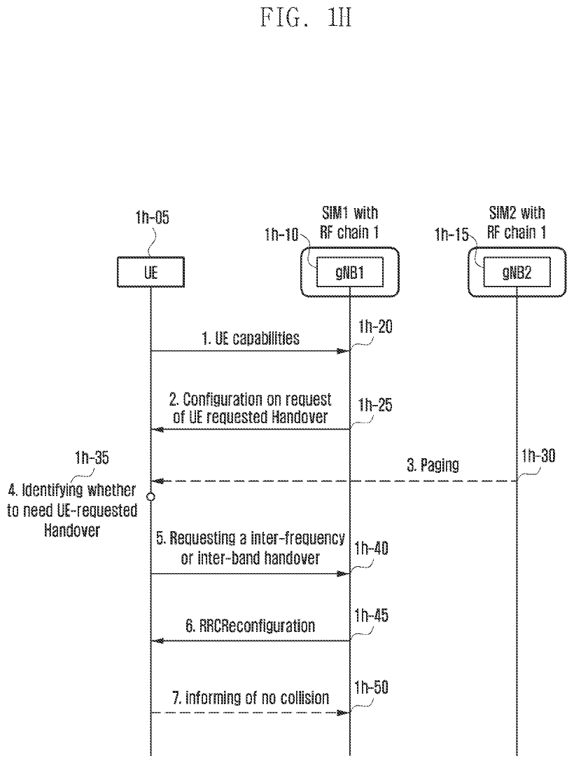

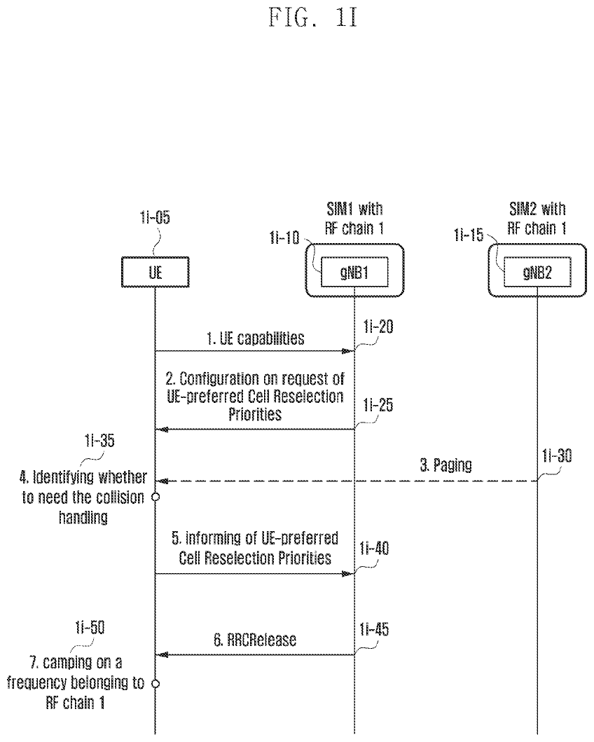

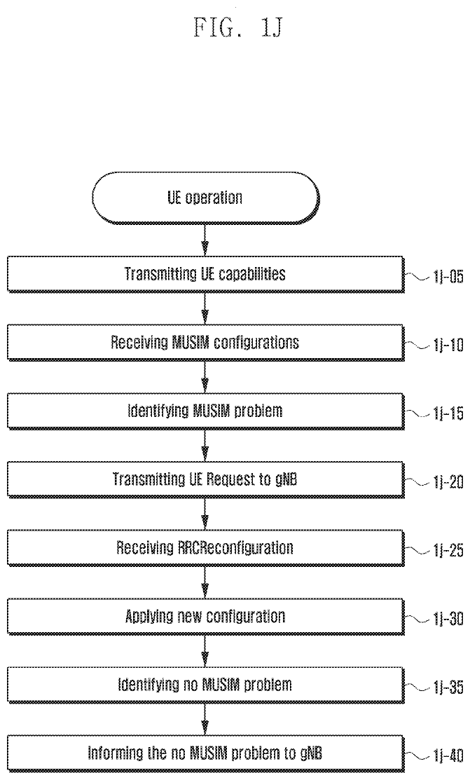

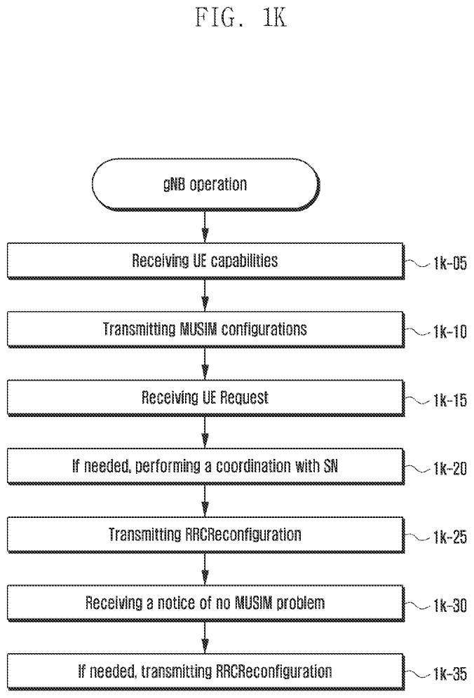

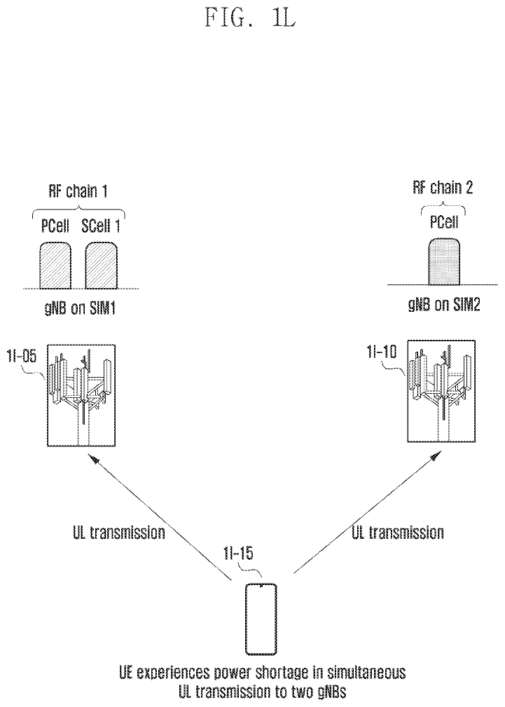

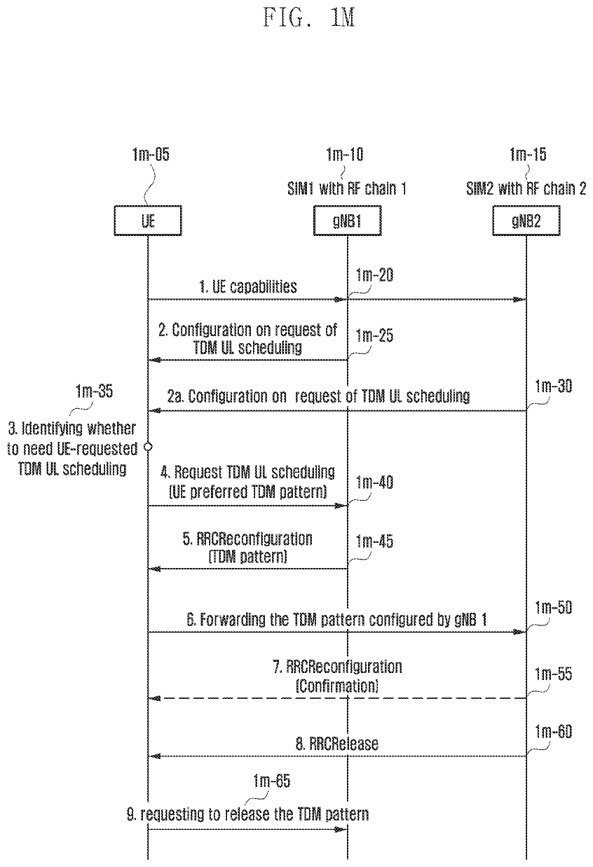

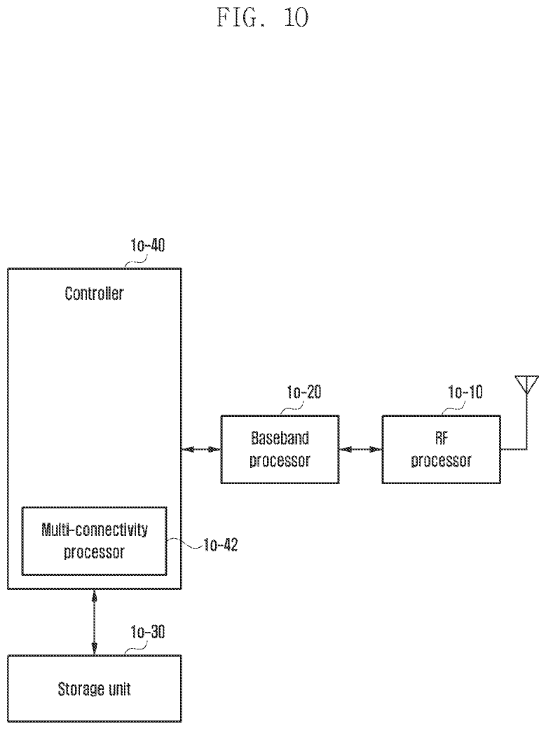

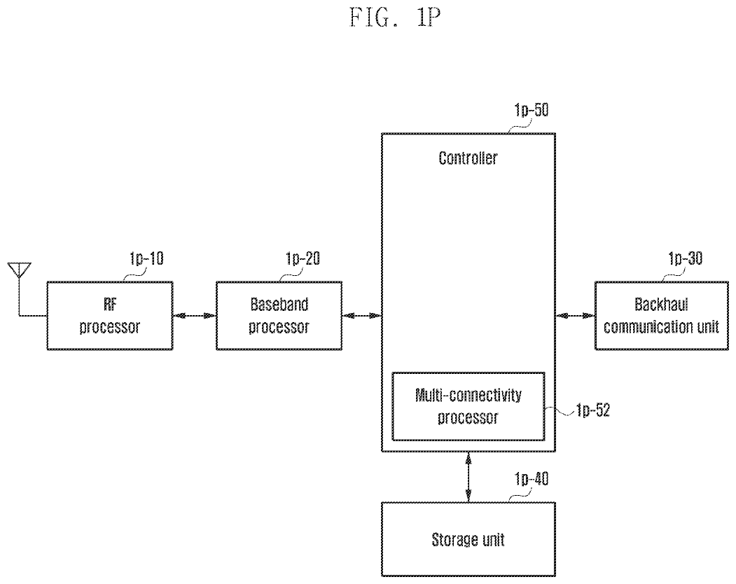

FIG. 1A illustrates a structure of a next-generation mobile communication system according to an embodiment of the disclosure.

Referring to FIG. 1A, as illustrated therein, a radio access network of a next-generation mobile communication system (new radio, NR) includes a next-generation base station (new radio node B (gNB) or NR base station) 1a-10 and an access and mobility management entity (AMF, new radio core network) 1a-05. A user equipment (new radio user equipment (NR UE) or NR terminal) 1a-15 accesses an external network via the gNB 1a-10 and the AMF 1a-05.

In FIG. 1A, the gNB 1a-10 corresponds to an evolved node B (eNB) of a conventional LTE system. The gNB 1a-10 is connected to the NR UE 1a-15 through a radio channel and may provide outstanding services as compared to a conventional node B 1a-30 (1a-20). In the next-generation mobile communication system, since all user traffic is serviced through a shared channel, a device that collects state information, such as buffer states, available transmit power states, and channel states of UEs, and performs scheduling accordingly is required, and the gNB 1a-10 serves as the device. In general, one gNB 1a-10 controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to channel states of the UE 1a-15. The AMF 1a-05 performs functions such as mobility support, bearer configuration, and QoS configuration. The AMF 1a-05 is a device responsible for various control functions as well as a mobility management function for the UE 1a-15, and is connected to multiple base stations. In addition, the next-generation mobile communication system may interwork with the existing LTE system, and the AMF 1a-05 is connected to an MME 1a-25 via a network interface. The MME 1a-25 is connected to the eNB 1a-30 that is a conventional base station. The UE 1a-15 supporting LTE-NR dual connectivity may transmit/receive data while maintaining connections to both the gNB 1a-10 and the eNB 1a-30.

FIG. 1B is a diagram for illustrating a radio access state transition in a next-generation mobile communication system according to an embodiment of the disclosure.

Referring to FIG. 1B, the next-generation mobile communication system has three radio access states (RRC states). A connected mode (RRC_CONNECTED) 1b-05 is a radio access state in which a terminal may transmit or receive data. A standby mode (RRC IDLE) 1b-30 is a radio access state in which the terminal monitors whether paging is transmitted to itself. The two modes are radio access states which are also applied to the conventional LTE system, and detailed technologies are the same as those of the conventional LTE system. In the next-generation mobile communication system, an inactive (RRC_INACTIVE) radio access state 1b-15 has been newly defined. In the radio access state, a UE context is maintained in a base station and the terminal, and radio access network (RAN)-based paging is supported. Characteristics of the new radio access state are as follows.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN; and
NR RAN knows the RAN-based notification area which the UE belongs to

The new INACTIVE radio access state 1b-15 may be transitioned to the connected mode 1b-05 or the standby mode 1b-30 by using a specific procedure. In operation 1b-25, the INACTIVE mode 1b-15 may be switched 1b-10 to the connected mode 1b-05 according to Resume, and the connected mode 1b-05 may be switched to the INACTIVE mode 1b-30 by using Release including suspend configuration information. In the procedure, one or more RRC messages are transmitted and received between the terminal and the base station, and one or more operations are included. In addition, via Release after Resume, it is possible to switch 1b-20 from the INACTIVE mode 1b-15 to the standby mode 1b-30. Switching between the connected mode 1b-05 and the standby mode 1b-30 follows the conventional LTE technology. That is, via Establishment or Release, switching between the modes may be performed 1b-25.

FIG. 1C is a diagram illustrating a terminal supporting multiple subscriber identity modules (SIMs) according to an embodiment of the disclosure.

Referring to FIG. 1C, a SIM is a device in which information of a mobile communication subscriber is stored, and a terminal 1c-15 uses the information stored in the device to register in and connect to a network provided by a service provider to which the subscriber has subscribed. The multi-SIM terminal 1c-15 according to an embodiment of the disclosure is a terminal that supports two or more SIMs 1c-20 and 1c-25. The multi-SIM terminal 1c-15 may operate in a first mode (hereinafter, referred to as a dual SIM dual standby (DSDS) mode) or a second mode (hereinafter, referred to as a dual SIM dual active (DSDA) mode). The DSDS mode and the DSDA mode may be defined as follows.
DSDS: Both SIMs can be used for idle-mode network connection, but when a radio connection 1c-05 is active, the second connection 1c-10 is disabled. As in the passive case, the SIMs in a DSDS device share a single transceiver. Through time multiplexing, two radio connections are maintained in idle mode. When in-call on network for one SIM, it is no longer possible to maintain radio connection to the network of the second SIM, hence, that connection is unavailable for the duration of the call. Registration to the second network is maintained.
DSDA: Both SIMs can be used in both idle and connected modes. Each SIM has a dedicated transceiver, meaning that there are no interdependencies on idle or connected mode operation at the modem level

If the terminal 1c-15 supporting multiple SIMs has one radio frequency (RF) chain (or transceiver), a collision may occur when data is transmitted and received in a connected mode associated with a first network corresponding to a first SIM 1c-20 and paging is received from a second network corresponding to a second SIM 1c-25. Therefore, in this case, the terminal 1c-15 may have difficulty in monitoring paging transmitted from the second network corresponding to the second SIM 1c-25, or performing other standby mode operations (e.g., receiving system information and public warning system (PWS) information, tracking area update (TAU), etc.). TAU is a procedure of re-registering a paging area periodically or when the terminal reselects a cell having a different tracking area (TA), and the terminal 1c-15 needs to be connected to the network. In this case, the terminal 1c-15 needs transmission and reception to and from the network. Therefore, the terminal 1c-15 may not perform TAU depending on transmission and reception of another network Here, an RF chain is a term commonly used in the communications field, and refers to a collection of a series of RF modules (an antenna, an amplifier, a converter/decoder, a filter, etc.) required for data transmission and reception.

If the terminal 1c-15 supports two RF chains, services may be concurrently received from two networks corresponding to the respective different SIMs 1c-20 and 1c-25 without the aforementioned problem. However, when a carrier aggregation (CA)/dual connectivity (DC) technology is configured in a network corresponding to one SIM, and thus the terminal 1c-15 supporting two RF chains uses both the two RF chains, there is still a need for a method capable of smoothly performing a standby mode or connected mode operation in another other network. The disclosure proposes methods capable of smoothly performing a standby mode or connected mode operation in another other network in consideration of the multi-SIM terminal 1c-15 supporting the second mode. The standby mode operation refers to paging monitoring and reception, system information reception, public warning system (PWS) information reception, TAU, and the like. The connected mode operation refers to performing, by the terminal 1c-15, data transmission and reception to and from base stations 1c-05 and 1c-10.

FIG. 1D is a diagram for illustrating scenarios in which a terminal having multiple RF chains receives services from multiple networks corresponding to different SIMs according to an embodiment of the disclosure.

Referring to FIG. 1D, a terminal supporting two RF chains may concurrently receive services from two networks corresponding to respective different SIMs. That is, the terminal may be able to assign one RF chain per network (hereinafter, referred to as a SIM network) corresponding to each SIM. However, when various performance improvement technologies, such as carrier aggregation (CA) or dual connectivity (DC) are configured, the terminal may need to assign both the two RF chains to one SIM network. In such scenarios, the terminal still requires a certain technology to smoothly receive services associated with two SIM networks. Scenarios considered in the disclosure, in which the terminal having a first RF chain and a second RF chain supports two networks having different SIMs, are as follows.

A first scenario proposed in (a) of FIG. 1D is a case where, for a CA operation with a first SIM network, the terminal uses both the first RF chain and the second RF chain for communication with the first SIM network, and uses the second RF chain to receive paging from a second SIM network or needs new communication with the second SIM network. In the scenario, in order for the terminal to still receive smooth services associated with the two SIM networks, the terminal may request deactivation or periodic or aperiodic scheduling suspension (scheduling gap) of secondary cells (SCells) belonging to the second RF chain in the first SIM network.

A second scenario proposed in (b) of FIG. 1D is a case where, for a DC operation with the first SIM network, the terminal uses both the first RF chain and the second RF chain for communication with the first SIM network, and uses the second RF chain to receive paging from the second SIM network or needs new communication with the second SIM network. In this case, in the first SIM network, the terminal uses the first RF chain for communication with a master node (MN) and uses the second RF chain for communication with a secondary node (SN). In the scenario, in order for the terminal to still receive smooth services associated with the two SIM networks, the terminal may request deactivation or periodic or aperiodic scheduling suspension (scheduling gap) of a secondary cell group (SCG) of the first SIM network.

A third scenario proposed in (c) of FIG. 1D is a case where, for a DC operation with the first SIM network, the terminal uses both the first RF chain and the second RF chain for communication with the first SIM network, and uses the second RF chain to receive paging from the second SIM network or needs new communication with the second SIM network. In this case, the terminal uses the first RF chain and the second RF chain for communication with the MN in the first SIM network, and uses the second RF chain for communication with the SN. In the scenario, in order for the terminal to still receive smooth services associated with the two SIM networks, the terminal may request deactivation or periodic or aperiodic scheduling suspension (scheduling gap) of the SCells belonging to the second RF chain and the SCG in the first SIM network.

A fourth scenario proposed in (d) of FIG. 1D is a case where, the terminal uses the first RF chain for communication with the first SIM network, and uses the first RF chain to receive paging from the second SIM network or needs new communication with the second SIM network. In the scenario, in order for the terminal to still receive smooth services associated with the two SIM networks, the terminal may request handover (inter-frequency or inter-band handover) to another frequency or frequency band which may use the second RF chain in the first SIM network, or request a change or redirection of a paging transmission frequency in the second SIM network.

FIG. 1E is a flowchart of operations for performing deactivation or release based on a terminal request according to an embodiment of the disclosure.

Referring to FIG. 1E, in the embodiment, when a terminal 1e-05 supporting a first RF chain and a second RF chain uses the second RF chain to receive paging from a second SIM network 1e-20 or new communication with the second SIM network 1e-20 is necessary, the terminal 1e-05 requests deactivation or release of a specific master cell group (MCG) SCell, a specific SCG SCell, an SCG (i.e., all cells belonging to an SN 1e-15, a primary secondary cell (PSCells) and SCells), or a specific frequency band (i.e., all cells belonging to a specific frequency band) of a first SIM network involved in the second RF chain. The terminal 1e-05 may report, to a base station, the current configuration or activated cell(s) involved in the second RF chain or a frequency band involved in the second RF chain, and may request the base station to perform deactivation or release. The request may be transmitted to an MN 1e-10 or the SN 1e-15 of the first SIM network.

Normally, the terminal 1e-05 may use an SCell via two operations of configuring and activating. That is, the base station may configure at least one specific SCell for the terminal 1e-05 by using a predetermined RRC message (e.g., RRCReconfiguration). Then, w % ben the base station activates the preconfigured SCell by using a predetermined medium access control (MAC) control element (CE), the terminal 1e-05 may perform data transmission and reception via the SCell. Even when the SCell is not in use, the two-operation procedure of deactivation and release is followed. A reason for introducing the (de)activation procedure is to maintain a configuration even when the terminal 1e-05 does not use the specific SCell, so as to quickly use the SCell later when necessary. However, a predetermined special-purposed cell, such as a PSCell, is available without the (de)activation procedure.

SCG deactivation technology has been introduced in Rel-17, and when an SCG is temporarily not used, the SCG may be deactivated instead of being released. That is, all cells belonging to the SCG may be collectively deactivated via a predetermined operation. Therefore, when the terminal 1e-05 requests the base station to deactivate the SCG belonging to the second RF chain in the above scenario, the base station may use Rel-17 SCG deactivation to deactivate the SCG in response to the terminal request. If Rel-17 SCG deactivation is recycled, the terminal 1e-05 may, for communication of the second SIM network, transmit an indicator (or cause value), which indicates requesting of the SCG deactivation, to the first SIM network by using a predetermined RRC message.

The terminal 1e-05 may report 1e-25 terminal capability information to the MN 1e-10 of the first SIM network. The capability information may include an indicator indicating whether the terminal 1e-05 supports terminal request-based deactivation/release to solve a collision in a multi-SIM environment. The capability information may also include information on a frequency band supported by the terminal 1e-05, wherein information indicating a frequency band, for which each RF chain of the terminal 1e-05 is available, may also be included.

The MN 1e-10 may configure 1e-30 the terminal request-based deactivation/release for the terminal 1e-05 by using a predetermined RRC message. In addition, the CA or DC technology may be configured for the first SIM network, so that the terminal 1e-05 may use both the first RF chain and the second RF chain.

In operation 1e-35, the terminal 1e-05 may receive paging from the second SIM network 1e-20 by using the second RF chain or recognize that new communication with the second SIM network 1e-20 is necessary.

The terminal 1e-05 may recognize 1e-40 that deactivation or release of an SCell or SCG involved in the second RF chain may be necessary for communication with the second SIM network 1e-20.

The terminal 1e-05 may request 1e-45 or 1e-55 the MN 1e-10 or SN 1e-15 of the first SIM network to deactivate/release the SCell or SCG involved in the second RF chain. The request information may be included in a predetermined RRC message or a predetermined MAC CE so as to be transmitted to the base station 1e-10 or 1e-15. The request information may include information on a frequency band or information on the SCell that needs to be deactivated or released. There may be multiple requested SCells and frequency bands. The information on the SCell may include at least an SCell index value used to indicate the SCell. The SCell may be included in the MN 1e-10 or the SN 1e-15. The information on the frequency band may include at least a band index value used to indicate the frequency band. The base station 1e-10 or 1e-15 having received the frequency band may consider that all cells belonging to the frequency band need be deactivated or released. In addition, the request information may include an indicator or cause value indicating that a purpose is to solve a collision in the multi-SIM environment, and may include an indicator indicating whether the reported SCell or band needs to be deactivated or released. If all cells belonging to the SCG are involved in the second RF chain and need be deactivated, the terminal 1e-05 may trigger SCG deactivation. In this case, the terminal 1e-05 may request SCG deactivation by using the predetermined RRC message or the predetermined MAC CE, wherein the SCG deactivation request may include the indicator or cause value indicating that the purpose is to solve a collision in the multi-SIM environment. During the request, the deactivation/release of specific SCells belonging to the MCG and the SCG deactivation may be requested concurrently via a single RRC message or MAC CE.

If the base station 1e-10 or 1e-15 identifies the frequency band and information on the RF chain supporting the same in advance via the terminal capability information, the terminal 1e-05 may include, in the request information, an index value of the RF chain that needs be deactivated or released. Since the base station 1e-10 or 1e-15 has knowledge of the frequency band or SCells corresponding to the RF chain, the corresponding SCells may be deactivated or released.

In order to prevent the terminal 1e-05 from frequently reporting the request, a predetermined prohibit timer may be introduced. When the terminal 1e-05 reports one request, the timer may be driven, and another request may not be able to be reported before the timer expires.

If the terminal 1e-05 has reported the request information to the MN 1e-10, and at least one SCell belonging to the SCG is indicated or SCG deactivation is indicated in the request, the MN 1e-10 may discuss 1e-50 the request with the SN 1e-15 to determine SCG SCell or SCG deactivation in response to the request. In this case, in operation 1e-50, the MN 1e-10 may forward at least request information related to the SCG in the request information to the SN 1e-15, and the SN 1e-15 may transfer, to the MN 1e-10, whether the request of the terminal 1e-05 is acceptable.

If the target, for which the terminal 1e-05 requests deactivation or release, is associated only with the SCG, i.e., in the case of SCG SCell deactivation/release or SCG deactivation, the terminal 1e-05 may directly transmit 1e-55 the request information to the SN 1e-15. In this case, the terminal 1e-05 may use preconfigured SRB3.

In response to the request, the MN 1e-10 may provide 1e-60 information on the frequency band or SCell which needs to be deactivated or released or whether to perform SCG deactivation to the terminal 1e-05 by using a predetermined RRC message or a predetermined MAC CE. For deactivation of a specific SCell, conventional SCell activation/deactivation MAC CE may be used. The MN 1e-10 may switch the specific SCell to a dormant state instead of deactivating or releasing the same.

Despite the terminal request, if the terminal 1e-05 is not provided with preferred configuration information from the base station 1e-10 or 1e-15, the terminal 1e-05 may perform SCell/SCG deactivation or release on its own after a predetermined time elapses from the request. In order to configure the predetermined time, the base station 1e-10 or 1e-15 may provide corresponding timer information to the terminal 1e-05 via a predetermined RRC message. If the timer information is not provided to the terminal 1e-05, this indicates that the terminal 1e-05 is not allowed to perform SCell/SCG deactivation or release on its own.

If the terminal 1e-05 reports the request to the SN 1e-15, the SN 1e-15 may provide 1e-65 information on the SCell that needs to be deactivated or released or whether to perform SCG deactivation to the terminal 1e-05 by using an RRC message or predetermined MAC CE (over SRB3). For deactivation of a specific SCell, conventional SCell activation/deactivation MAC CE may be used.

When the second RF chain no longer needs to be used for the second SIM network 1e-20, the terminal 1e-05 may notify 1e-70 of the same to the first SIM network 1e-10 or 1e-15. The first SIM network 1e-10 or 1e-15 having recognized the same may activate or configure an SCell or SCG using the second RF chain again by using a predetermined RRC message or a predetermined MAC CE, in operation 1e-75. For activation of a specific SCell, conventional SCell activation/deactivation MAC CE may be used. As another example, the terminal 1e-05 may automatically activate a deactivated SCell or SCG after a specific time elapses. To this end, the base station 1e-10 or 1e-15 may provide the specific time information to the terminal 1e-05.

FIG. 1F is a flowchart of operations for performing scheduling suspension (scheduling gap) periodically or aperiodically based on a terminal request according to an embodiment of the disclosure.

Referring to FIG. 1F, in the embodiment, when a terminal 1f-05 supporting a first RF chain and a second RF chain uses the second RF chain to receive paging from a second SIM network, the terminal 1f-05 requests periodically or aperiodically scheduling suspension (scheduling gap) of a specific MCG SCell, a specific SCG SCell, an SCG (i.e., all cells belonging to an SN, a PSCell and SCells), or a specific frequency band (i.e., all cells belonging to a specific frequency band) of a first SIM network involved in the second RF chain. The terminal 1f-05 may report, to a base station, the current configuration or activated cell(s) involved in the second RF chain or a frequency band involved in the second RF chain, and may request the base station to configure a scheduling gap for the same. The request may be transmitted to an MN 1f-10 or an SN 1f-15 of the first SIM network. The scheduling gap refers to a time interval in which data transmission and reception scheduling of the base station is suspended periodically or aperiodically. During a corresponding time period, no measurement is performed on serving cells of the corresponding base station. Therefore, during a scheduling gap, the terminal 1f-05 may receive a predetermined signal from the second SIM network.

The terminal 1f-05 may report 1f-25 terminal capability information to the MN 1f-10 of the first SIM network. The capability information may include an indicator indicating whether the terminal 1f-05 supports a terminal request-based scheduling gap operation to solve a collision in the multi-SIM environment. The capability information may also include information on a frequency band supported by the terminal 1f-05, wherein information indicating a frequency band, for which each RF chain of the terminal 1f-05 is available, may also be included.

The MN 1f-10 may configure 1f-30 the terminal request-based scheduling gap operation for the terminal 1f-05 by using a predetermined RRC message. In addition, the CA or DC technology may be configured for the first SIM network, so that the terminal 1f-05 may use both the first RF chain and the second RF chain.

The terminal 1f-05 may recognize 1f-35 that paging reception from the second SIM network 1f-20 by using the second RF chain is necessary.

The terminal 1f-05 may recognize 1f-40 that a scheduling gap is necessary for an SCell or SCG involved in the second RF chain, for communication with the second SIM network 1f-20.

The terminal 1f-05 may request 1f-45 or 1f-55 the MN 1f-10 or SN 1f-15 of the first SIM network to configure a scheduling gap. The request information may be included in a predetermined RRC message or a predetermined MAC CE so as to be transmitted to the base station 1f-10 or 1f-15. The request information may include SCell information, frequency band information, or cell group (i.e., MCG or SCG) information to which the scheduling gap needs to be applied, and may include a single piece or multiple pieces of scheduling gap pattern information preferred by the terminal 1f-05. If multiple scheduling gaps are included in the request information, SCell information, frequency band information, or a cell group, to which each scheduling gap is to be applied, may be provided separately. The terminal 1f-05 may determine the preferred scheduling gap information by considering a period of paging monitoring in the second network 1f-20. The TS 38.331 standard document is referenced for timing of monitoring the paging. The preferred scheduling gap information may include at least an offset value and a gap pattern length value. The offset value is used to derive a time point at which the periodic gap pattern begins, and the network suspends data transmission and reception during a length of the gap pattern. In this case, a subframe and a system frame number (SFN) of a special cell (spCell) (i.e., PCell or PSCell) in the first SIM network 1f-10 or 1f-15 may be used as a reference for the offset. The terminal 1f-05 may calculate whether the current subframe or slot belongs to the gap, by substituting the configured offset value and the current SFN and subframe values of spCell into a predetermined equipment.

There may be multiple requested SCells and frequency bands. The SCell information may include at least an SCell index value used to indicate the SCell. The SCell may be included in the MN 1f-10 or the SN 1f-15. The frequency band information may include at least a band index value used to indicate the frequency band. The base station 1f-10 or 1f-15 having received the frequency band may consider that the scheduling gap requested by the terminal 1f-05 needs to be applied to all cells belonging to the frequency band. In addition, the request information may include an indicator or cause value indicating that a purpose is to solve a collision in the multi-SIM environment. If all cells belonging to the SCG are involved in the second RF chain and a single scheduling gap preferred by the terminal 1f-05 needs to be applied, the terminal 1f-05 will request a single scheduling gap desired to be applied to the SCG.

If the base station 1f-10 or 1f-15 identifies the frequency band and information on the RF chain supporting the same in advance via the terminal capability information, the terminal 1f-05 may include, in the request information, an index value of the RF chain to which the scheduling gap needs to be applied. Since the base station 1f-10 or 1f-15 has knowledge of the frequency band or SCells corresponding to the RF chain, the scheduling gap requested by the terminal 1f-05 may be configured for the corresponding SCells.

In order to prevent the terminal 1f-05 from frequently reporting the request, a predetermined prohibit timer may be introduced. When the terminal 1f-05 reports one request, the timer may be driven, and another request may not be able to be reported before the timer expires.

If the terminal 1f-05 has reported the request information to the MN 1f-10, and at least one SCell belonging to the SCG is indicated or the SCG is indicated in the request, the MN 1f-10 may discuss 1f-50 the request with the SN 1f-15 to determine applying of the scheduling gap preferred by the terminal to the SCG SCell or the SCG in response to the request. In this case, in operation 1f-50, the MN 1f-10 may forward at least request information related to the SCG in the request information to the SN 1f-15, and the SN 1f-15 may transfer, to the MN 1f-10, whether the request of the terminal 1f-05 is acceptable.

If the target, for which the terminal 1f-05 requests the scheduling gap, is associated only with the SCG, the terminal 1f-05 may directly transmit 1f-55 the request information to the SN 1f-15. In this case, the terminal 1f-05 may make the request using preconfigured SRB3.

In response to the request, the MN 1f-10 may provide 1f-60 the single piece or multiple pieces of scheduling gap pattern information and the SCell information or cell group or frequency band information, to which each scheduling gap needs to be applied, to the terminal 1f-05 by using a predetermined RRC message or a predetermined MAC CE.

If the terminal 1f-05 reports the request to the SN 1f-15, the SN 1f-15 may provide 1f-65 the single piece or multiple pieces of scheduling gap pattern information and the SCell information or cell group or frequency band information, to which each scheduling gap needs to be applied, to the terminal 1f-05 by using an RRC message or predetermined MAC CE (over SRB3).

When the second RF chain no longer needs to be used for the second SIM network 1f-20, the terminal 1f-05 may notify 1f-70 of the same to the first SIM network 1f-10 or 1f-15. The first SIM network 1f-10 or 1f-15 having recognized the same may be configured 1f-75 to release the preconfigured scheduling gap by using a predetermined RRC message or a predetermined MAC CE. As another example, the terminal 1f-05 may automatically release the preconfigured scheduling gap after a specific time elapses. To this end, the base station 1f-10 or 1f-15 may provide the specific time information to the terminal 1f-05.

FIG. 1G is a flowchart of operations for performing SCG change based on a terminal request according to an embodiment of the disclosure.

Referring to FIG. 1G, in the embodiment, when a terminal 1g-05 supporting a first RF chain and a second RF chain uses the second RF chain to receive paging from a second SIM network or new communication with the second SIM network is necessary, the terminal 1g-05 requests to change a specific cell or an SCG of a first SIM network, which is involved in the second RF chain, to a frequency or frequency band not involved in the second RF chain. The terminal 1g-05 may report, to a base station, preconfigured cell or SCG information involved in the second RF chain and a frequency or frequency band not involved in the second RF chain, and may request, from the base station, a specific cell or SCG change by using the frequency or the frequency band. The request may be transmitted to an MN 1g-10 or an SN 1g-15 of the first SIM network.

Dual connectivity (DC) is a technology that dramatically increases a data transmission and reception rate of the terminal 1g-05. If the terminal 1g-05 configured with the DC technology wants to maintain a high data transmission and reception rate via the first SIM network even regarding the aforementioned multi-SIM collision, it may be preferable to change cells (e.g., PSCell and SCell) involved in the second RF chain to a frequency or frequency band supportable using the first RF chain, rather than deactivating the cells involved in the second RF chain or applying a scheduling gap to the cells.

The SCG change refers to at least adding or changing of a PSCell. In other words, the SCG change refers to adding (SCG addition) or changing of a PSCell, which enables all basic functions to be performed to operate the SCG. In the embodiment, in relation to a collision with another network, since the purpose is to change all cells of the preconfigured SCG to a different frequency or frequency band so as to avoid a collision, the SCG change in the embodiment may refer to changing and configuring all cells belonging to the SCG.

The terminal 1g-05 may report 1g-25 terminal capability information to the MN 1g-10 of the first SIM network. The capability information may include an indicator indicating whether the terminal 1g-05 supports a terminal request-based cell or SCG change operation to solve a collision in the multi-SIM environment. The capability information may also include information on a frequency band supported by the terminal 1g-05, wherein information indicating a frequency band, for which each RF chain of the terminal 1g-05 is available, may also be included.

The MN 1g-10 may configure 1g-30 the terminal request-based cell or SCG change operation for the terminal 1g-05 by using a predetermined RRC message. In addition, the CA or DC technology may be configured for the first SIM network, so that the terminal 1g-05 may use both the first RF chain and the second RF chain.

In operation 1g-35, the terminal 1g-05 may receive paging from the second SIM network 1g-20 by using the second RF chain or recognize that new communication with the second SIM network 1g-20 is necessary.

The terminal 1g-05 may recognize 1g-40 that an SCell or SCG involved in the second RF chain needs to be changed for communication with the second SIM network 1g-20.

The terminal 1g-05 may request 1g-45 or 1g-55 a cell or SCG change operation from the MN 1g-10 or SN 1g-15 of the first SIM network. The request information may be included in a predetermined RRC message or a predetermined MAC CE so as to be transmitted to the base station 1g-45 or 1e-55. The request information may include SCell information or SCG information that needs to be changed. The reported SCell or SCG is currently supported by the second RF chain. There may be multiple requested SCells. The SCell information may include at least an SCell index value used to indicate the SCell, and may include information on at least one frequency or frequency band preferred by the terminal 1g-05 for each SCell. The frequency or frequency band that the terminal 1g-05 reports is supportable using the first RF chain. The SCell may be included in the MN 1g-10 or the SN 1g-15. If the terminal 1g-05 prefers the SCG change, the request information may include, along with an indicator indicating the same, information on at least one frequency or frequency band preferred by the terminal 1g-05. The frequency band information may include at least a band index value used to indicate the frequency band. The frequency information may include a center frequency, a preferred frequency bandwidth based on the center frequency, a preferred frequency range (upper and lower bound), etc. In addition, the request information may include an indicator or cause value indicating that a purpose is to solve a collision in the multi-SIM environment.

If the base station 1g-10 or 1g-15 identifies the frequency band and information on the RF chain supporting the same in advance via the terminal capability information, the terminal 1g-05 may include, in the request information, an index value of the RF chain that needs to be changed. Since the base station 1g-10 or 1g-15 has knowledge of the frequency band or SCells corresponding to the RF chain, the corresponding SCells may be changed.

In order to prevent the terminal 1g-05 from frequently reporting the request, a predetermined prohibit timer may be introduced. When the terminal 1g-05 reports one request, the timer may be driven, and another request may not be able to be reported before the timer expires.

If the terminal 1g-05 has reported the request information to the MN 1g-10, and at least one SCell belonging to the SCG is indicated or the SCG change is indicated in the request, the MN 1g-10 may discuss 1g-50 the request with the SN 1g-15 to determine the SCG SCell or SCG change in response to the request. In this case, in operation 1g-50, the MN 1g-10 may forward at least request information related to the SCG in the request information to the SN 1g-15, and the SN 1g-15 may transfer, to the MN 1g-10, whether the request of the terminal 1g-05 is acceptable.

If the target, for which the terminal 1g-05 requests the change, is associated only with the SCG, i.e., the SCG SCell change or SCG change, the terminal 1g-05 may directly transmit 1g-55 the request information to the SN 1g-15. In this case, the terminal 1g-05 may use preconfigured SRB3.

In response to the request, the MN 1g-10 may provide 1g-60, to the terminal 1g-05 by using a predetermined RRC message, the SCell or SCG change indicated by the terminal 1g-05 to the frequency or frequency band preferred by the terminal.

If the terminal 1g-05 reports the request to the SN 1g-15, the SN 1g-15 may provide 1g-65, to the terminal 1g-05 by using a predetermined RRC message (over SRB3), the SCell or SCG change indicated by the terminal 1g-05 to the frequency or frequency band preferred by the terminal 1g-05.

When the second RF chain no longer needs to be used for the second SIM network 1g-20, the terminal 1g-05 may notify 1g-70 of the same to the first SIM network 1g-10 or 1g-15. The first SIM network 1g-10 or 1g-15 having recognized the same may change 1g-75 the SCell or SCG to the frequency or frequency band using the second RF chain again by using a predetermined RRC message. As another example, the terminal 1g-05 may automatically change the SCell or SCG to the frequency or frequency band using the second RF chain after a specific time elapses. To this end, the base station 1g-10 or 1g-15 may provide the specific time information to the terminal 1g-05.

FIG. 1H is a flowchart of operations for performing inter-frequency or inter-band handover based on a terminal request according to an embodiment of the disclosure.

Referring to FIG. 1H, in the embodiment, when a terminal 1h-05 supporting a first RF chain and a second RF chain uses the first RF chain to receive paging from a second SIM network or new communication with the second SIM network is necessary, the terminal 1h-05 requests handover from a first SIM network involved in the first RF chain. The terminal 1h-05 may report, to a base station 1h-10, a frequency or frequency band supportable using the second RF chain, and may request, from the base station 1h-10, handover to the frequency or frequency band.

Changing a PCell to another cell as the terminal 1h-05 moves is called handover. In the scenario, if a PCell of the first SIM network is handed over to a cell supportable using the second RF chain, the terminal 1h-05 may perform data transmission and reception by assigning the first RF chain and the second RF chain to the second SIM network and the first SIM network, respectively. In this case, since the RF chains need be changed, inter-frequency or inter-band handover will have to be performed.

The terminal 1h-05 may report 1h-20 terminal capability information to the MN 1h-10 of the first SIM network. The capability information may include an indicator indicating whether the terminal 1h-05 supports terminal request-based handover to solve a collision in the multi-SIM environment. The capability information may also include information on a frequency band supported by the terminal 1h-05, wherein information indicating a frequency band, for which each RF chain of the terminal 1h-05 is available, may also be included.

The MN 1h-10 may use a predetermined RRC message to configure 1h-25, for the terminal 1h-05, that handover may be requested.

In operation 1h-30, the terminal 1h-05 may receive paging from the second SIM network 1h-15 by using the first RF chain or recognize that new communication with the second SIM network 1h-15 is necessary.

The terminal 1h-05 may recognize 1h-35 that handover of the first SIM network 1h-10 that is using the first RF chain may be necessary for communication with the second SIM network 1h-15.

The terminal 1h-05 may request 1h-40, from the MN 1h-10 of the first SIM network, inter-frequency or inter-band handover. Information on the handover request may be included in a predetermined RRC message or a predetermined MAC CE so as to be transmitted to the base station or 1h-10. The request information may include information on a frequency or frequency band supportable using the second RF chain by the terminal 1h-05. In addition, the request information may include an indicator indicating that inter-RAT handover is preferred or possible. The frequency band information may include at least a band index value used to indicate the frequency band. The frequency information may include a center frequency, a preferred frequency bandwidth based on the center frequency, a preferred frequency range (upper and lower bound), etc. In addition, the request information may include an indicator or cause value indicating that a purpose is to solve a collision in the multi-SIM environment.

If the base station 1h-10 identifies the frequency band and information on the RF chain supporting the same in advance via the terminal capability information, the terminal 1h-05 may include an index value of the RF chain requiring handover in the request information. Since the base station 1h-10 has knowledge of the frequency or frequency band corresponding to the RF chain, handover may be configured according thereto.

In order to prevent the terminal 1h-05 from frequently reporting the request, a predetermined prohibit timer may be introduced. When the terminal 1h-05 reports one request, the timer may be driven, and another request may not be able to be reported before the timer expires.

In response to the request, the MN 1h-10 may configure 1h-45 handover to be performed to a frequency or frequency band preferred by the terminal 1h-05.

When the first RF chain no longer needs to be used for the second SIM network, the terminal 1h-05 may notify 1h-50 of the same to the first SIM network 1h-10. The first SIM network having recognized the same may perform, using a predetermined RRC message, handover again to the frequency or frequency band using the first RF chain. As another example, the terminal 1h-05 may automatically perform handover to the frequency or frequency band using the first RF chain after a specific time elapses. To this end, the base station 1h-10 may provide the specific time information to the terminal 1h-05.

FIG. 1I is a flowchart of operations for determining cell reselection priority information based on a terminal request according to an embodiment of the disclosure.

Referring to FIG. 1I, in the embodiment, when a terminal 1i-05 supporting a first RF chain and a second RF chain uses the second RF chain to receive paging from a second SIM network 1i-15 or performs communication with the second SIM network 1i-15, the terminal 1i-05 provides cell reselection priority information preferred by the terminal 1i-05 to the connected first SIM network 1i-10 by using the first RF chain. The terminal 1i-05 may report, to the base station 1i-10, a frequency or frequency band in use (or supportable using the second RF chain) for the current second SIM network 1i-15, and may request that the frequency is excluded from cell reselection candidates or is assigned with a low priority when the base station 1i-10 configures dedicated cell reselection priority information that is included in an RRCRelease message to be provided. Alternatively, conversely, the terminal 1i-05 may report, to the base station 1i-10, a frequency or frequency band supportable using the first RF chain, and may request that the frequency is assigned with a high priority.

The base station 1i-10 may provide cell reselection priority information to the terminal 1i-05 via a system information block (SIB) or an RRCRelease message. The base station 1i-10 may assign priority to each frequency, and the terminal 1i-05 provided with the information may preferentially reselect a frequency having a high priority by considering both the priority and a reception signal quality. The terminal 1i-05 may apply the priority information, which is provided via the RRCRelease message, preferentially over the information provided via the SIB.

In the embodiment, the terminal 1i-05 may report, to the base station 1i-10, an expected multi-SIM collision in advance, so that, when the base station 1i-10 configures the cell reselection priority information, the expected collision may be considered.

The terminal 1i-05 may report 1i-20 terminal capability information to the MN 1i-10 of the first SIM network. The capability information may include an indicator indicating whether the terminal 1i-05 supports reporting of cell reselection priority information preferred by the terminal 1i-05, to solve a collision in the multi-SIM environment. The capability information may also include information on a frequency band supported by the terminal 1i-05, wherein information indicating a frequency band, for which each RF chain of the terminal 1i-05 is available, may also be included.

The MN 1i-10 may use a predetermined RRC message to configure 1i-25, for the terminal 1i-05, that the preferred cell reselection priority information may be reported.

In operation 1i-30, the terminal 1i-05 may receive paging from the second SIM network 1i-15 by using the second RF chain or recognize that communication with the second SIM network 1i-15 is necessary.

The terminal 1i-05 may recognize 1i-35 that, for communication with the second SIM network 1i-15, it is necessary to provide the cell reselection priority information to the first SIM network 1i-10 that is using the first RF chain.

The terminal 1i-05 may report 1i-40, to the MN 1i-10 of the first SIM network, priority information for each frequency (not) preferred by the terminal 1i-05. The information may be included in a predetermined RRC message or a predetermined MAC CE so as to be transmitted to the base station or 1i-10.

If the base station 1i-10 identifies the frequency band and information on the RF chain supporting the same in advance via the terminal capability information, the terminal 1i-05 may include, in the request information, an index value of the RF chain that needs to be assigned with a low (or high) priority. Since the base station 1i-10 has knowledge of the frequency or frequency band corresponding to the RF chain, priority for each frequency may be determined according thereto.

In order to prevent the terminal 1i-05 from frequently reporting the request, a predetermined prohibit timer may be introduced. When the terminal 1i-05 reports one request, the timer may be driven, and another request may not be able to be reported before the timer expires.

In response to the request, the MN 1i-10 may transmit 1i-05 the RRCRelease message including the cell reselection priority information to the terminal 1i-05.

The terminal 1i-05 may perform camp-on 1i-50 by preferentially reselecting the frequency supportable using the first RF chain. According to the embodiment, the terminal 1i-05 may automatically delete the provided cell reselection priority information after a specific time elapses, and to this end, the base station 1i-10 may provide information on the specific time to the terminal 1i-05.

FIG. 1 is a flowchart of terminal operations for operations based on a terminal request according to an embodiment of the disclosure.

Referring to FIG. 1I, in operation 1j-05, a terminal may report capability information thereof to a base station. The capability information may include an indicator indicating whether to support the following operations.
UE-requested Per-cell (or per-band) deactivation/release
UE-requested Per-cell (or per-band or a cell group) scheduling gap
UE-requested Cell or SCG change
UE-requested Handover
UE-preferred Cell Reselection Priorities

In operation 1j-10, the terminal may receive, from the base station, configuration information indicating whether the operations can be performed. The configuration information may be provided to the terminal via an RRCReconfiguration message.

In operation 1j-15, the terminal may recognize that a multi-SIM collision occurs due to communication with another network.

In operation 1j-20, the terminal may trigger at least one of the operations and report, to the base station, a configuration preferred by the terminal. The terminal may include information on the preferred configuration in a UEAssistanceInformation message and transmit the message.

In operation 1j-25, the terminal may receive, from the base station, the information on the configuration preferred by the terminal. The information on the configuration may be provided to the terminal via an RRCReconfiguration message.

In operation 1j-30, the terminal may apply new configuration information provided by the base station.

In operation 1j-35, the terminal may recognize that a multi-SIM collision no longer occurs.

In operation 1j-40, the terminal may report, to the base station, information associated with the fact that a multi-SIM collision has no longer occurred.

FIG. 1K is a flowchart of base station operations for operations based on a terminal request according to an embodiment of the disclosure.

Referring to FIG. 1K, in operation 1k-05, a base station may receive capability information from a terminal.

In operation 1k-10, the base station may transmit, to the terminal, configuration information indicating whether the operations can be performed.

In operation 1k-15, the base station may receive, from the terminal, a configuration preferred by the terminal.

In operation 1k-20, when necessary, the base station may review, with an SN, whether to allow the configuration.

In operation 1k-25, the base station may transmit configuration information reflecting the preference to the terminal.

In operation 1k-30, the base station may receive, from the terminal, a report that a multi-SIM collision no longer occurs.

In operation 1k-35, when necessary, the base station may transmit new configuration information for which solving a multi-SIM collision has not been considered.

FIG. 1L is a diagram for illustrating a problem of insufficient terminal transmission power when a terminal having multiple RF chains receives services from multiple networks corresponding to different SIMs according to an embodiment of the disclosure.

If a terminal 1l-15 supporting a first RF chain and a second RF chain uses the respective RF chains to support different networks 1l-05 and 1l-10, no collision between network communications occurs. However, in a specific case, the terminal 1l-15 may be restricted in transmitting uplink data to the respective network 1l-05 and 1l-10. For example, if the terminal 1l-15 is located in a service area border region of the two networks 1l-05 and 1l-10, the terminal 1l-15 may lack terminal transmission power to concurrently transmit uplink data to the two networks 1l-05 and 1l-10. Therefore, in this situation, the terminal 1l-15 needs to avoid transmitting uplink data concurrently to the two networks 1l-05 and 1l-10. On the other hand, no restriction occurs when the terminal 1l-15 receives downlink data.

In the embodiment, the terminal 1l-15 experiencing the problem above requests time divisional multiplex (TDM) scheduling from the two networks 1l-05 and 1l-10. Each TDM scheduling requested to each of the two networks 1l-05 and 1l-10 does not overlap, and transmission of uplink data to one network at one point may be configured. If at least one network does not allow TDM scheduling requested by the terminal 1l-15, the terminal 1l-15 may practically select one network at one point and transmit uplink data.

FIG. 1M is a flowchart of operations for performing TDM scheduling based on a terminal request according to an embodiment of the disclosure.

Referring to FIG. 1M, a terminal 1m-05 supporting a first RF chain and a second RF chain uses the respective RF chains to communicate with different networks 1m-10 and 1m-15. The terminal 1m-05 may report 1m-20 capability information thereof to base stations of the respective networks 1m-10 and 1m-15. The capability information may include an indicator indicating whether terminal-requested TDM scheduling is supported.

The base stations 1m-10 and 1m-15 of the respective networks may configure 1m-25 and 1m-30 an operation capable of reporting, to the terminal 1m-05, an uplink TDM pattern preferred by the terminal 1m-05.

The terminal 1m-05 may recognize 1m-35 that the amount of transmission power of the terminal 1m-05 itself cannot satisfy a transmission power required to transmit uplink data concurrently to the base stations 1m-10 and 1m-15.

The terminal 1m-05 may report 1m-40, to the base station 1m-10 of the first network, information on an uplink TDM pattern preferred by the terminal 1m-05 by using a predetermined RRC message. In this case, the terminal 1m-05 may determine the TDM pattern in consideration of a ratio of the amount of uplink data generated in each network.

The TDM pattern information may be used to indicate a network to which uplink data may be transmitted in each subframe, slot, transmission block, transmission block group, code block, or code block group in units of subframes, slots, transmission blocks, transmission block groups, code blocks, or code block groups. Synchronization of the TDM pattern conforms to synchronization of the network 1m-10 to which the terminal 1m-05 reports the pattern.

The base station 1m-10 may use a predetermined RRC message or a predetermined MAC CE or L1 signaling, which includes an indicator for approval of the reported TDM pattern, and transmit 1m-45 the same to the terminal. If the base station 1m-10 wants to allow a pattern different from the pattern requested by the terminal 1m-05, the base station 1m-10 may transmit preferred pattern information to the terminal 1m-05.

The terminal 1m-05 may also transmit 1m-50, to the other network 1m-15, the TDM pattern allowed from the one network 1m-10. Synchronization in the two networks 1m-10 and 1m-15 may be different, and therefore. TDM patterns reported by the terminal 1m-05 to the two networks 1m-10 and 1m-15 may be different.

The base station 1m-15 may use a predetermined RRC message or a predetermined MAC CE or L1 signaling, which includes an indicator for approval of the reported TDM pattern, and transmit 1m-55 the same to the terminal 1m-05. The terminal 1m-05 having received the approval message may apply the approved TDM pattern from a predetermined time point, and transmit uplink data to each base station 1m-10 or 1m-15.

In another embodiment, the terminal 1m-05 may report the TDM pattern to the two base stations 1m-10 and 1m-15 without waiting for the approval message from one base station 1m-10 or 1m-15. In this case, each base station 1m-10 or 1m-15 may transmit whether the pattern has been approved to the terminal 1m-05 by using a predetermined RRC message or a predetermined MAC CE or L1 signaling. The terminal 1m-05 having received the approval message from the specific base station 1m-10 or 1m-15 may apply the approved TDM pattern from a predetermined time point, and transmit uplink data to each base station 1m-10 or 1m-15.

When communication with the second network 1m-15 is terminated 1m-60, the terminal 1m-05 may notify 1m-65 the first network 1m-10 that there is no need to apply the TDM pattern.

FIG. 10 is a block diagram illustrating an internal structure of a terminal according to an embodiment of the disclosure.

Referring to FIG. 1O, a terminal includes a radio frequency (RF) processor 1o-10, a baseband processor 1o-20, a storage unit 1o-30, and a controller 1o-40.

The RF processor 1o-10 performs a function for transmitting and receiving a signal via a radio channel, such as signal band transform and signal amplification. That is, the RF processor 1o-10 up-converts a baseband signal provided from the baseband processor 1o-20 into an RF band signal, transmits the converted RF band signal through an antenna, and then down-converts the RF band signal received through the antenna into a baseband signal. For example, the RF processor 1o-10 may include a transmission filter, a reception filter, an amplifier, a mixer, an oscillator, a digital-to-analog converter (DAC), an analog-to-digital converter (ADC), and the like. Although only one antenna is illustrated in FIG. 10, the terminal may include multiple antennas. In addition, the RF processor 1o-10 may include multiple RF chains. Furthermore, the RF processor 1o-10 may perform beamforming. For the beamforming, the RF processor 1o-10 may adjust a phase and a magnitude of each of signals transmitted and received through multiple antennas or antenna elements. In addition, the RF processor 1o-10 may perform MIMO, and may receive multiple layers when performing a MIMO operation.

The baseband processor 1o-20 performs conversion between a baseband signal and a bitstream according to a physical layer specification of a system. For example, during data transmission, the baseband processor 1o-20 generates complex symbols by encoding and modulating a transmission bitstream. In addition, during data reception, the baseband processor 1o-20 reconstructs a reception bitstream via demodulation and decoding of a baseband signal provided from the RF processor 1o-10. For example, when conforming to an orthogonal frequency division multiplexing (OFDM) scheme, during data transmission, the baseband processor 1o-20 generates complex symbols by encoding and modulating a transmission bitstream, maps the complex symbols to sub-carriers, and then configures OFDM symbols by performing an inverse fast Fourier transform (IFFT) operation and cyclic prefix (CP) insertion. In addition, during data reception, the baseband processor 1o-20 divides the baseband signal provided from the RF processor 1o-10 in units of OFDM symbols, reconstructs signals mapped to subcarriers via a fast Fourier transform (FFT) operation, and then reconstructs the reception bitstream via demodulation and decoding.

The baseband processor 1o-20 and the RF processor 1o-10 transmit and receive signals as described above. Accordingly, the baseband processor 1o-20 and the RF processor 1o-10 may be referred to as a transmitter, a receiver, and a transceiver, or a communication unit. Furthermore, one of the baseband processor 1o-20 and the RF processor 1o-10 may include multiple communication modules to support multiple different radio access technologies. In addition, at least one of the baseband processor 1o-20 and the RF processor 1o-10 may include different communication modules to process signals of different frequency bands. For example, the different radio access technologies may include a wireless LAN (e.g., IEEE 802.11), a cellular network (e.g., LTE), and the like. Further, the different frequency bands may include a super-high frequency (SHF) (e.g., 2.NRHz, NRhz) band and a millimeter wave (e.g., 60 GHz) band.

The storage unit 1o-30 stores data, such as basic programs, application programs, and configuration information for operation of the terminal. The storage unit 1o-30 provides stored data in response to a request of the controller 1o-40.

The controller 1o-40 controls overall operations of the terminal. For example, the controller 1o-40 transmits and receives a signal via the baseband processor 1o-20 and the RF processor 1o-10. The controller 1o-40 records and reads data in the storage unit 1o-40. To this end, the controller 1o-40 may include at least one processor. For example, the controller 1o-40 may include a communication processor (CP) configured to perform control for communication and an application processor (AP) configured to control a higher layer, such as an application program.

FIG. 1P is a block diagram illustrating a configuration of a base station according to an embodiment of the disclosure.

Referring to FIG. 1P, a base station includes an RF processor 1p-10, a baseband processor 1p-20, a backhaul communication unit 1p-30, a storage unit 1p-10, and a controller 1p-50.

The RF processor 1p-10 performs a function for transmitting and receiving a signal via a radio channel, such as signal band transform and signal amplification. That is, the RF processor 1p-10 up-converts a baseband signal provided from the baseband processor 1p-20 into an RF band signal, transmits the converted RF band signal through an antenna, and then down-converts the RF band signal received through the antenna into a baseband signal. For example, the RF processor 1p-10 may include a transmission filter, a reception filter, an amplifier, a mixer, an oscillator, a DAC, an ADC, and the like. Although only one antenna is illustrated in FIG. 1P, the base station may include multiple antennas. In addition, the RF processor 1p-10 may include multiple RF chains. Furthermore, the RF processor 1p-10 may perform beamforming. For the beamforming, the RF processor 1p-10 may adjust a phase and a magnitude of each of signals transmitted and received through the multiple antennas or antenna elements. The RF processor 1p-10 may perform a downlink MIMO operation by transmitting one or more layers.

The baseband processor 1p-20 performs a function of conversion between a baseband signal and a bitstream according to a physical layer specification of a radio access technology. For example, during data transmission, the baseband processor 1p-20 generates complex symbols by encoding and modulating a transmission bitstream. In addition, during data reception, the baseband processor 1p-20 reconstructs a reception bitstream via demodulation and decoding of a baseband signal provided from the RF processor 1p-10. For example, when conforming to the OFDM scheme, during data transmission, the baseband processor 1p-20 generates complex symbols by encoding and modulating a transmission bitstream, maps the complex symbols to sub-carriers, and then configures OFDM symbols by performing IFFT operation and CP insertion. In addition, during data reception, the baseband processor 1p-20 divides the baseband signal provided from the RF processor 1p-10 in units of OFDM symbols, reconstructs signals mapped to subcarriers via a fast Fourier transform (FFT) operation, and then reconstructs the reception bitstream via demodulation and decoding.

The baseband processor 1p-20 and the RF processor 1p-10 transmit and receive signals as described above. Accordingly, the baseband processor 1p-20 and the RF processor 1p-10 may be referred to as a transmitter, a receiver, a transceiver, a communication unit, or a wireless communication unit.

The backhaul communication unit 1p-30 provides an interface that performs communication with other nodes within a network. That is, the backhaul communication unit 1p-30 converts a bitstream transmitted from the base station to another node, for example, another base station (e.g., an auxiliary base station), a core network, etc., into a physical signal, and converts a physical signal received from the another node into a bitstream.

The storage unit 1p-40 stores data, such as basic programs, application programs, and configuration information for operation of the base station. Particularly, the storage unit 1p-40 may store information on a bearer assigned to a connected terminal, a measurement result reported from the connected terminal, and the like. In addition, the storage unit 1p-40 may store information serving as a criterion for determining whether to provide the terminal with multiple connections or to suspend the same. In addition, the storage unit 1p-40 provides stored data in response to a request of the controller 1p-50.

The controller 1p-50 controls overall operations of the base station. For example, the controller 1p-50 transmits and receives a signal via the baseband processor 1p-20 and the RF processor 1p-10 or via the backhaul communication unit 1p-30. In addition, the controller 1p-50 records and reads data in the storage unit 1p-40. To this end, the controller 1p-50 may include at least one processor.

It should be noted that the configuration diagrams, illustrative diagrams of control/data signal transmission methods, illustrative diagrams of operation procedures, and structural diagrams as illustrated in FIG. 1A to FIG. 1P are not intended to limit the scope of protection of the disclosure. That is, all the constituent units, entities, or operation steps shown in FIG. 1A to FIG. 1P should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units and modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a terminal in a wireless communication system, the method comprising:
identifying that the terminal has a preference for at least one serving cell to be released for a multi universal subscriber identity module (MUSIM) operation;
transmitting, to a base station, a message including information on the at least one serving cell which the terminal prefers to be released.

17. The method of claim 16,
wherein the information on the at least one serving cell includes at least one of information to identify the at least one serving cell or information on a secondary cell group (SCG) which the terminal prefers to be released.

18. The method of claim 16,
wherein the message further includes information on at least one band to be avoided.

19. The method of claim 16,
wherein the message further includes a user equipment (UE) assistance information message.

20. The method of claim 16, further comprising:
transmitting, to the base station, information indicating that a measurement gap is required for the terminal in the MUSIM operation.

21. A method performed by a base station in a wireless communication system, the method comprising:
in case that a terminal has a preference for at least one serving cell to be released for a multi universal subscriber identity module (MUSIM) operation, receiving, from the terminal, a first message including information on the at least one serving cell which the terminal prefers to be released; and
transmitting, to the terminal, a second message including configuration information based on the information on the at least one serving cell which the terminal prefers to be released.

22. The method of claim 21,
wherein the information on the at least one serving cell includes at least one of information to identify the at least one serving cell or information on a secondary cell group (SCG) which the terminal prefers to be released.

23. The method of claim 21,
wherein the first message further includes information on at least one band to be avoided.

24. The method of claim 21,
wherein the first message further includes a user equipment (UE) assistance information message.

25. The method of claim 21, further comprising:
receiving, from the terminal, information indicating that a measurement gap is required for the terminal in the MUSIM operation.

26. A terminal in a wireless communication system, the terminal comprising:
a transceiver; and
a controller configured to:
identify that the terminal has a preference for at least one serving cell to be released for a multi universal subscriber identity module (MUSIM) operation, and
transmit, to a base station, via the transceiver, a message including information on the at least one serving cell which the terminal prefers to be released.

27. The terminal of claim 26,
wherein the information on the at least one serving cell includes at least one of information to identify the at least one serving cell or information on a secondary cell group (SCG) which the terminal prefers to be released.

28. The terminal of claim 26,
wherein the message further includes information on at least one band to be avoided.

29. The terminal of claim 26,
wherein the message further includes a user equipment (UE) assistance information message.

30. The terminal of claim 26, wherein the controller is further configured to:
transmit, to the base station, via the transceiver, information indicating that a measurement gap is required for the terminal in the MUSIM operation.

31. A base station in a wireless communication system, the base station comprising:
a transceiver; and
a controller configured to:
in case that a terminal has a preference for at least one serving cell to be released for a multi universal subscriber identity module (MUSIM) operation, receive, from the terminal, via the transceiver, a first message including information on the at least one serving cell which the terminal prefers to be released, and
transmit, to the terminal, via the transceiver, a second message including configuration information based on the information on the at least one serving cell which the terminal prefers to be released.

32. The base station of claim 31,
wherein the information on the at least one serving cell includes at least one of information to identify the at least one serving cell or information on a secondary cell group (SCG) which the terminal prefers to be released.

33. The base station of claim 31,
wherein the first message further includes information on at least one band to be avoided.

34. The base station of claim 31,
wherein the first message further includes a user equipment (UE) assistance information message.

35. The base station of claim 31, wherein the controller is further configured to:
receive, from the terminal, information indicating that a measurement gap is required for the terminal in the MUSIM operation.
